(19) United States
(12) Patent Application Publication
(10) Pub. No.: US 2008/0320593 A1
(43) Pub. Date: Dec. 25, 2008

(54) Method, System and Computer Readable Medium For Intrusion Control

(75) Inventors: Asaf Greiner, Jerusalem (IL); Yair Tor, Rannana (IL)

Correspondence Address: RECHES PATENTS, 211 NORTH UNION STREET, SUITE 100, ALEXANDRIA, VA, 22314, US

(73) Assignee: BEEFENCE LTD, Tel Aviv (IL)

(21) Appl. No.: 11/816,914

(22) PCT Filed: Feb. 28, 2006
(86) PCT No.: PCT/IL06/00268

§ 371 Date: Aug. 23, 2007

Related U.S. Application Data
(60) Provisional application No. 60/659,413, filed on Mar. 9, 2005.

(51) Int. Cl. G06F 21/00

(52) U.S. Cl. 726/23

(57) ABSTRACT

An intrusion control system, method and computer readable medium. The system includes an input interface adapted to receive traffic over a session opened between a user and a computerized system; and a processor, adapted to control the session while determining whether the traffic is a part of an attack. The method includes determining an occurrence of an attack; and mitigating the attack by providing false information representative of a defense capability of a computerized system.

### FIELD OF THE INVENTION

The inventions relates to systems, computer readable mediums and methods for intrusion control, especially in computerized networks.

### BACKGROUND OF THE INVENTION

Modem computerized systems are threatened by intrusive attacks. Intrusion detection systems (IDS) are aimed to detect intrusive attacks and to generate alerts whenever an intrusive attack is detected. Typical intrusion detection systems use signature based detection methods and/or protocol analysis based methods. These methods can include, for example, port assignment, port following, protocol tunneling detection, protocol analysis, RFC compliance checking, TCP reassembly, flow assembly, statistical threshold analysis, pattern matching and the like.

IDS evolved to intrusion prevention systems (IPS). There are three major types of IPS systems, network IPS systems, host IPS systems and node IPS systems. These systems are positioned in various locations of a network, host or node accordingly and passively monitor (or sniff) various packets, files or activities.

The following U.S. patents applications publication numbers 2003/0097557, 2003/0084326 and 2003/0084329 of Tarquini, all being incorporated herein by reference, provide a brief overview of some prior art intrusion prevention systems.

A typical IPS system will block a session or even block an IP address whenever it determines that that session is a part of an intrusive attack or when intrusive attacks originated from the certain IP address.

An IPS system is characterized by its false positive rate and its false negative rate. A false positive includes erroneously defining, by the IPS, legitimate traffic as an illegitimate traffic. False negative include defining, by the IPS, illegitimate traffic as legitimate traffic.

Because false negatives can result in blocking legitimate traffic, many IPS system are configured to provide a low false positive rate. Accordingly, the false negative rate is relatively high.

By merely blocking sessions or even IP addresses the IPD notifies the attacker that the illegitimate traffic was detected. Such an IPS system provides the attacker with valuable information about the computerized system defenses. A sophisticated attacker can them modify his current attack of his future attack.

These mentioned above drawbacks prevent current IPS systems to be widely deployed. In many cases IPS systems are actually used as IDS systems. In some cases IPS cases are allowed to block only a small amount of detected attacks.

There is a need to provide an efficient intrusion control system.

### SUMMARY OF THE INVENTION

A method for intrusion control that includes: receiving at least one alert representative of an occurrence of a suspected attack; and determining whether to perform an active validation of the occurrence of an attack.

A method for intrusion control that includes: determining an occurrence of an attack; and mitigating the attack by providing false information representative of a defense capability of a computerized system.

A method for intrusion control that includes: receiving traffic over a session opened between a user and a computerized system; and controlling the session while determining whether the traffic is a part of an attack.

An intrusion control system, that includes: an input interface that is adapted to receive at least one alert representative of an occurrence of a suspected attack; and a processor that is adapted to determine whether to perform an active validation of the occurrence of an attack.

An intrusion control system that includes: an input interface adapted to receive traffic, and a processor adapted to determine an occurrence of an attack and to mitigate the attack by providing false information representative of a defense capability of a computerized system.

An intrusion control system that includes: an input interface adapted to receive traffic over a session opened between a user and a computerized system; and a processor, adapted to control the session while determining whether the traffic is a part of an attack.

A computer readable medium having stored thereon a set of instructions, the set of instructions, when executed by a processor, cause the processor the perform a method that includes: receiving at least one alert representative of an occurrence of a suspected attack; and determining whether to perform an active validation of the occurrence of an attack.

A computer readable medium having stored thereon a set of instructions, the set of instructions, when executed by a processor, cause the processor the perform a method that includes: determining an occurrence of an attack; and mitigating the attack by providing false information representative of a defense capability of a computerized system.

A computer readable medium having stored thereon a set of instructions, the set of instructions, when executed by a processor, cause the processor the perform a method that includes: receiving traffic over a session opened between a user and a computerized system; and controlling the session while determining whether the traffic is a part of an attack.

### BRIEF DESCRIPTION OF THE DRAWINGS

The present invention will be understood and appreciated more fully from the following detailed description taken in conjunction with the drawings in which:

FIG. 1 illustrates a intrusion control system and its environment, according to an embodiment of the invention;

FIG. 2 illustrates a intrusion control system and another environment, according to an embodiment of the invention;

FIG. 3 is a block diagram of a intrusion control system, according to an embodiment of the invention; and

FIGS. 4-6 are flow charts of methods for intrusion control, according to various embodiments of the invention.

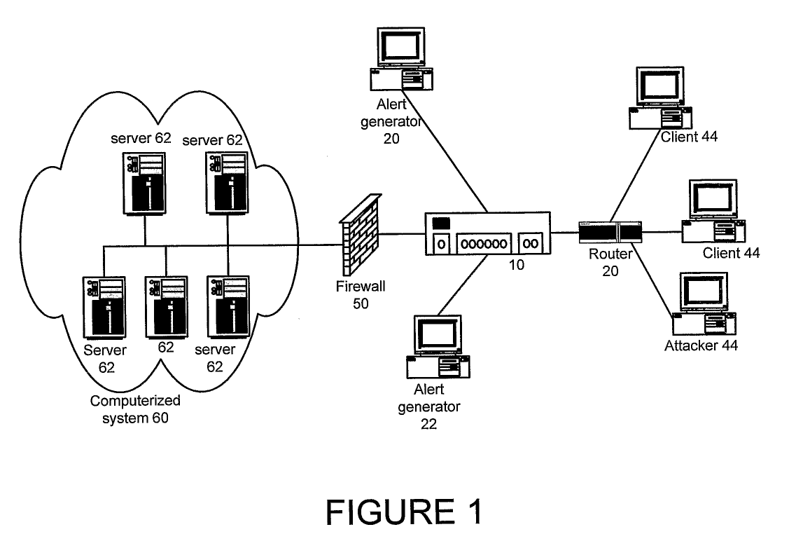

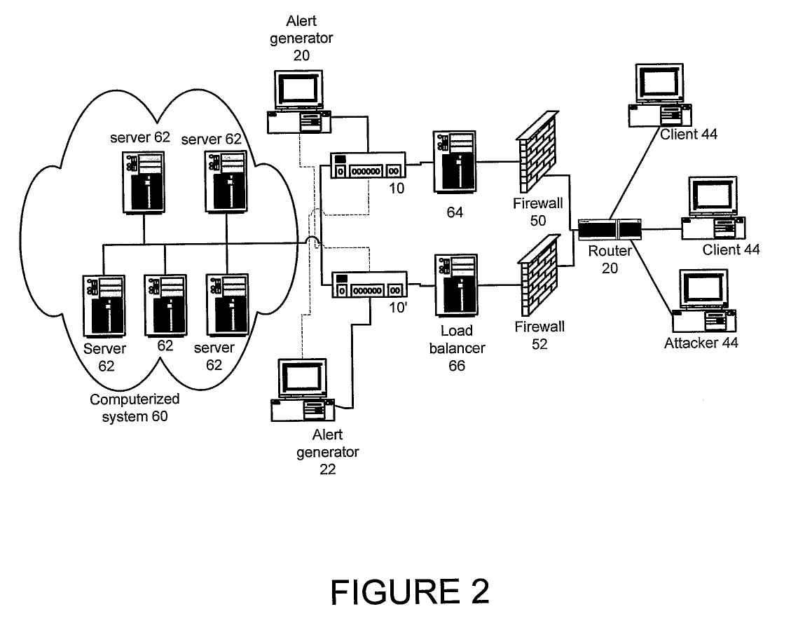

### DETAILED DESCRIPTION OF PREFERRED EMBODIMENTS

The following description refers to an intrusion control system that performs network or even perimeter layer intrusion control. It is noted that the invention can be applied mutatis mutandis to host layer and/or node layer intrusion control.

It is also noted that the disclosed methods and system can be applied in other networks, including networks that have different configurations than those described in the following figures. It is further noted that each network can use wired technology, satellite technology, wireless technology, electrical and/or optical technology and the like.

Each of the terms “intrusion”, “attack”, and “intrusive attack” means an illegal or unauthorized attempt to access or misuse a computer system and can involve stealing, destroying, manipulating, corrupting information and/or code or otherwise causing a computerized system to execute a code in an unauthorized manner. Said executed code can be provided during the attack but this is not necessarily so.

For convenience of explanation various examples refer to a protected network that includes servers. This is not necessarily so.

A typical intrusion scenario usually includes a preliminary stage of environmental probing or non-intrusive information gathering. This stage is followed by a more aggressive information gathering stage. After gaining enough information the attack stage usually begins. Intrusion detection sequences as well as initial counter-measures (such as but not limited to dynamic masquerading) can be applied even during the first and second stages. The intrusion control method starts with an initial intrusion detection. The initial detection causes one or more alerts to be generated by one or more alert generators.

According to an embodiment of the invention the intrusion control method processes one or more alert as well as additional information and associates a attack process probability (APP) to the attack process or to an attacker that initiated the attack process.

According to an embodiment of the invention if the APP is very low (for example, the APP is below a low_APP threshold) then the alert is ignored. Conveniently, if the APP is very high (for example, above a predefined high_APP threshold) the intrusion control process mitigates the attack. According to another embodiment of the invention if the APP is neither very high or very low the intrusion control process performs an active validation process in order to determine whether to ignore the alert or to perform mitigation.

Conveniently, the active validation involves using sessions that were initiated by a suspected attacker. The usage may include interrogating the potential attacker, sending queries, providing false information and the like. Conveniently, the validation is performed without alerting the attacker.

According to an embodiment of the invention the validation process includes multiple stages. The stages may differ by the amount of information sent to the potential attacker, the amount of quality of service degradation (if any) and the ability (or lack of ability) to reconnect the client to the protected server when the intrusion control system determines that the potential attacker is an innocent user.

Conveniently, the validation process asses the threat level associated with one or more alert. The validation process improves the decision process by providing more information about potential attacks or attackers. For example, past responses to various validation attempts may be used to detect an attacker.

In many cases an attacker will protect himself against various probing sessions by various means including firewalls and the like. The validation process bypasses the attacker defenses by using sessions that were initiated by the attacker. These sessions can be those who triggered the alarm or other sessions that are still active.

The validation process can assist in various cases, such as when a malicious activity is detected, but validation yields that the quality of the detection is not good enough.

Conveniently, the validation can apply various detection techniques and can add various inquiries. Conveniently, the intrusion control system will test the reactions of a potential attacker to various error messages, unexpected data and the like.

According to an embodiment of the invention the validation of a certain session can take into account past behavior of previously tagged attackers.

Conveniently, during the validation process various enquiries in various network levels are questioned.

According to another embodiment of the invention the validation process is designed such that at least some inquires will not be noticed by innocent users or otherwise will not depredate the service provided to an innocent user.

Non limiting examples of steps that can be applied during a validation process include: modifying the structure of a server response in unpredicted maimer to see client behavior; modifying the structure of server response in unpredicted manner to see the users behavior; or actively interrogating the user in various network levels.

According to an embodiment of the invention the intrusion control system can stop sending requests of a suspected client to the protected system and try to answer these requests, either by itself or by receiving information from the server. The answers can include status information or a partial response. Thus the intrusion control session can delay a provision of high value information while forcing the user to maintain the session. This process can end when the intrusion control system determines to mitigate the session or to define the session as a legitimate session.

Conveniently, during this buffering process the intrusion control system can perform validation steps and try to reveal the intentions of the user. Conveniently, the buffering stage can be performed in parallel to the active validation, but this is not necessarily so.

According to an embodiment of the invention an attack is mitigated by causing the attacker to lose interest in the protected system. This can include virtual patching or otherwise providing the attacker that the computerized system is protected against his attack.

According to an embodiment of the invention the intrusion control system increases the certainty level of its decisions by monitoring the behavior of potential attackers, their environment and the tools that are used by the attacker, and tagging attackers. Said tagging can be used in future sessions.

According to an embodiment of the invention the intrusion control system mitigates attacks and not merely blocks attacks. The mitigation is aimed to give attackers false information about the defenses of a computerized system, thus encouraging the attackers to stop attacking the system.

Conveniently, the attacker is not aware of the validation and mitigation process. Accordingly, it is very hard to distinguish between responses generated by the intrusion control system and the intended server within the computerized system.

Conveniently, the validation and mitigation processes are applied to each request or traffic provided by a user. Thus, legitimate requests of an attacker can be serviced.

According to an embodiment of the invention the mitigation stage includes dynamic masquerading, a normalization stage and an immunization stage. The dynamic masquerading is explained in better details in U.S. patent application titled “Method and apparatus for the dynamic defensive masquerading of computing resources”.

The normalization stage includes

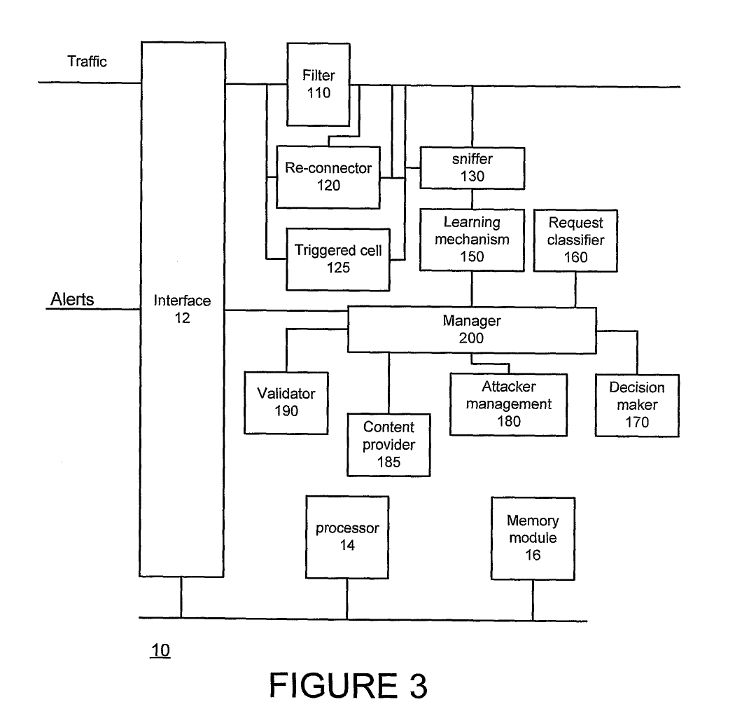

FIG. 3 illustrates an intrusion control system, according to an embodiment of the invention. Intrusion control system 10 includes various hardware and/or software components. It includes an input interface 12 for receiving either traffic or alerts and also includes a processor 14 and a memory module 16.

The processor 14 executes software codes that allows system 10 to perform various intrusion control stages. The processor either performs a stage, assists in the execution of the stage or controls other components of system 10 to perform various stages.

Some of the software components or software controlled hardware components include filter 110, re-connector 120, sniffer 130, trigger cell 140, learning mechanism 150, request classifier 160, decision maker 170, tracker 180, validator 190, trigger listener 210, control producer 230 and manager 200.

The

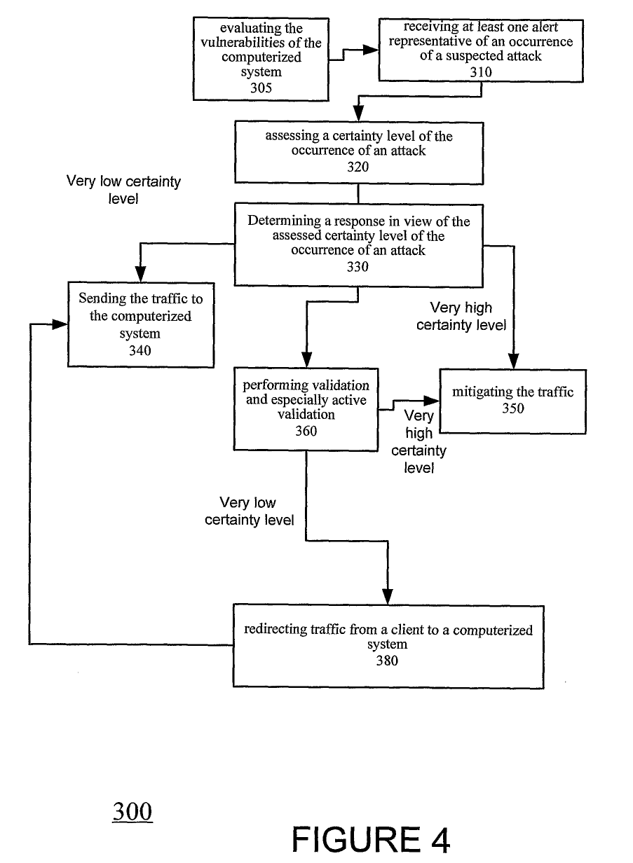

FIG. 4 illustrates a method 300 for intrusion control according to an embodiment of the invention. Method 300 starts by stage 310 of receiving at least one alert representative of an occurrence of a suspected attack.

Stage 310 is followed by stage 320 of assessing a certainty level of the occurrence of an attack. This stage can involve evaluating the reliability of the entity that provided the alert, performing an intrusion detection stage that may include analyzing the traffic that caused an alert, and the like.

According to an embodiment of the invention stage includes at least one of the following stages: (i) alert preprocessing, (ii) request classification, (iii) correlation with past events and other detection mechanisms, (iv) malicious level calculation and the like.

Stage 320 is followed by stage 330 of determining whether to perform an active validation of the occurrence of an attack. Conveniently, the determination is responsive to the certainty level.

Conveniently, stage 330 also includes determining whether to perform another action, in response to the certainty level. This can include determining to ignore the alert, if the certainty level is low, and to jump to stage 340 of ignoring the alert. In such a case traffic that is received by an intrusion control system can be sent (conveniently unchanged) to the computerized system.

Conveniently, stage 330 also includes determining whether to mitigate the traffic if the certainty level if high, and to jump to stage 350 of mitigating the traffic.

If stage 330 determines to perform active validation that stage 330 is followed by stage 360 of performing active validation.

Stage 360 of active validating conveniently ends by deciding whether to jump to stage 350 or to jump to stage 340, in response to the validated certainty level of an occurrence of an attack.

Stage 350 of mitigating can include providing at least one false representation of defense capabilities of a computerized system and/or providing a false representation of a patched computerized system. Stage 350 of mitigating can be designed such as to reduce the possibility of alerting the attacker.

Stage 330 can also be followed by stage 370 of buffering traffic from a suspected attacker while performing the active validation.

If the active validation stage determines that an attack occurs then stage 370 can be followed by stage 350, else stage 370 can be followed by stage 380 of redirecting traffic from a user to a computerized system if the traffic is regarded as a legitimate traffic. Stage 380 is followed by stage 340.

Conveniently, stage 360 of active validation includes validation stages that can differ from each other. They can differ by their intrusiveness, by the quality of service provided to the user, by the ability of perform reconnection and the like.

Conveniently, the determination of an occurrence of an attack and even the determination of whether to perform active validation is also responsive to the identity of the user that generated the traffic. Accordingly, method 300 also tries to determine if the user is an attacker, as illustrated by stage 325. It is noted that even if the method determines that a certain user is an attacker it can still service legitimate traffic provided by the attacker. It is further noted that various stages of method 300 (such as active validation) can be applied and be responsive to the identity of the user.

Stages 330-380 can be applied on a packet basis, on a group of packet basis, on a traffic conveyed during a session (or multiple sessions) basis, and the like.

Conveniently, the response (such as stages 340, 350, 360) to be applied is affected from a determination of whether a session was originated by an attacker.

Conveniently, stage 360 of active validation uses one or more sessions opened by an attacker.

According to an embodiment of the invention method 300 further comprises stage 305 of evaluating the vulnerabilities of the computerized system. This stage can be applied while other stages of method 300 are executed. These vulnerabilities can affect the response to an alert. These vulnerabilities can even influence the assessment of the a certainty level of the occurrence of an attack. For example, if a certain user tries to utilize one or more of said vulnerabilities then the method can assume that it is as attacker that previously learnt these vulnerabilities, but this is not necessarily so.

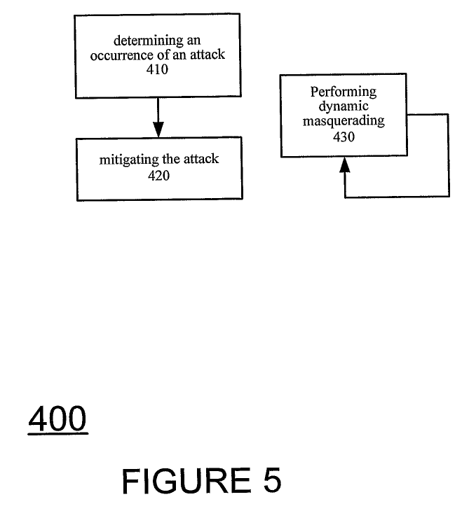

FIG. 5 illustrates a method 400 for intrusion control according to an embodiment of the invention. Method 400 starts by stage 410 of determining an occurrence of an attack.

Stage 410 is followed by stage 420 of mitigating the attack by providing false information representative of a defense capability of a computerized system.

Method 400 can also include stage 430 of performing dynamic masquerading. This stage is usually applied constantly, even before (or during) stage 410.

Conveniently, stage 420 of mitigating is designed such as to reduce the possibility of alerting the attacker.

Conveniently, stage 410 includes one or more stages of method 300, such as but not limited to stage 360 of performing active validation.

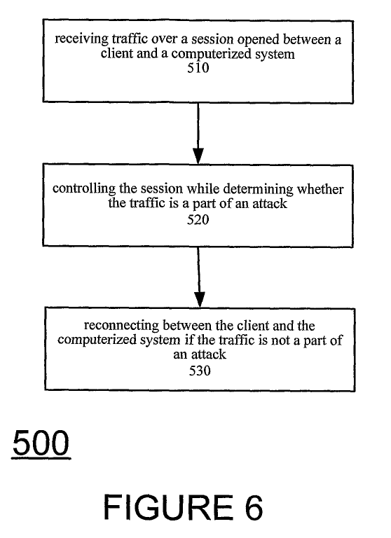

FIG. 6 illustrates a method 500 for intrusion control according to all embodiment of the invention. Method 500 starts by stage 510 of receiving traffic over a session opened between a user and a computerized system. Stage 510 is followed by stage 520 of and controlling the session while determining whether the traffic is a part of an attack.

Conveniently, the controlling includes emulating a response of the computerized system. The controlling can also include selectively proxying a portion of the traffic to the computerized system. According to an embodiment of the invention the controlling includes providing non-valuable information to the user while determining whether the traffic is a part of an attack.

Conveniently, the determining include one or more stages of method 300 such as but not limited to stage 360 of performing active validation.

Stage 520 is conveniently followed by stage 530 of reconnecting between the user and the computerized system if the traffic is not a part of an attack. Conveniently, stage 520 includes tracking a status of traffic such as to facilitate reconnecting the session opened between the user and the computerized system once the determination ended.

Stage 520 is conveniently followed by stage 540 of mitigating an attack by providing false information representative of a defense capability of a computerized system.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim:

1. A method for intrusion control, comprising: receiving at least one alert representative of an occurrence of a suspected attack; and determining whether to perform an active validation of the occurrence of an attack.

2. The method according to claim 1 comprising assessing a certainty level of the occurrence of the attack.

3. The method according to claim 2 wherein the determining is responsive to the certainty level.

4. The method according to claim 1 further comprising actively validating the occurrence of the attack in response to the determining.

5. The method according to claim I further comprising mitigating the attack.

6. The method according to claim 5 wherein the mitigating comprises providing at least one false representation of defense capabilities of a computerized system.

7. The method according to claim 5 wherein the mitigating comprises providing a false representation of a patched computerized system.

8. The method according to claim 5 wherein the mitigating is designed such as to reduce the possibility of alerting the attacker.

9. The method according to claim 1 further comprising buffering traffic from a suspected attacker while performing the active validation.

10. The method of claim 1 further comprising redirecting traffic from a user to a computerized system if the traffic is regarded as a legitimate traffic.

11. The method of claim 1 wherein the active validation comprises multiple validating stages that differ by their intrusiveness.

12. The method according to claim 1 wherein the active validation comprises multiple validating stages that differ by a level of quality of service provided to the user.

13. The method according to claim 1 further comprising determining whether a user that generated the traffic is an attacker.

14. The method according to claim 13 wherein the active validation is responsive to the determination of whether the user is an attacker.

15. The method according to claim 1 further comprising determining a response on a session basis.

16. The method according to claim 15 wherein determining the response is affected from a determination of whether a session was originated by an attacker.

17. The method according to claim 1 wherein the active validation uses one or more sessions opened by an attacker.

18. A method for intrusion control, comprising: determining an occurrence of an attack; and mitigating the attack by providing false information representative of a defense capability of a computerized system.

19. The method according to claim 18 further comprising dynamic masquerading.

20. The method according to claim 18 wherein the mitigating is designed such as to reduce the possibility of alerting the attacker.

21. The method according to claim 18 wherein the determining an occurrence of an attack comprises active validation.

22. A method for intrusion control, comprising: receiving traffic over a session opened between a user and a computerized system; and controlling the session while determining whether the traffic is a part of an attack.

23. The method according to claim 22 wherein the controlling comprises emulating a response of the computerized system.

24. The method according to claim 22 wherein the controlling comprises selectively proxying a portion of the traffic to the computerized system.

25. The method according to claim 22 wherein the controlling comprises providing non-valuable information to the user while determining whether the traffic is a part of an attack.

26. The method according to claim 22 further comprising reconnecting between the user and the computerized system if the traffic is not a part of an attack.

27. The method according to claim 22 wherein the controlling comprises tracking a status of traffic such as to facilitate reconnecting the session opened between the user and the computerized system once the determination ended.

28. The method according to claim 22 wherein the determining comprises determining whether to perform an active validation of the occurrence of an attack.

29. The method according to claim 22 further comprising mitigating an attack by providing false information representative of a defense capability of a computerized system.

30. An intrusion control system, comprising: an input interface that is adapted to receive at least one alert representative of an occurrence of a suspected attack; and a processor that is adapted to determine whether to perform an active validation of the occurrence of an attack.

31. The system according to claim 30 wherein the processor is adapted to assess a certainty level of the occurrence of the attack.

32. The system according to claim 31 wherein the determination is responsive to the certainty level.

33. The system according to claim 30 further adapted to actively validate the occurrence of the attack in response to the determining.

34. The system according to claim 1 further adapted to mitigate the attack.

35. The system according to claim 34 wherein the system is adapted to provide at least one false representation of defense capabilities of a computerized system.

36. The system according to claim 34 wherein system is adapted to provide a false representation of a patched computerized system.

37. The system according to claim 34 wherein the system mitigates the attack such as to reduce the possibility of alerting the attacker.

38. The system according to claim 1 further comprising a memory module adapted to buffer traffic from a suspected attacker while the system performs the active validation.

39. The system according to claim 30 further adapted to redirect traffic from a user to a computerized system if the traffic is regarded as a legitimate traffic.

40. The system according to claim 30 wherein the active validation comprises multiple validating stages that differ by their intrusiveness.

41. The system according to claim 30 wherein the active validation comprises multiple validating stages that differ by a level of quality of service provided to the user.

42. The system according to claim 30 further adapted to determine whether a user that generated the traffic is an attacker.

43. The system according to claim 42 wherein the active validation is responsive to the determination of whether the user is an attacker.

44. The system according to claim 30 further adapted to determine a response on a session basis.

45. The system according to claim 44 wherein the determination of the response is affected from a determination of whether a session was originated by an attacker.

46. The system according to claim 30 adapted to use, during the active validation, one or more sessions opened by an attacker.

47. An intrusion control system, comprising: an input interface adapted to receive traffic, and a processor adapted to determine an occurrence of an attack and to mitigate the attack by providing false information representative of a defense capability of a computerized system.

48. The system according to claim 47 further adapted to perform dynamic masquerading.

49. The system according to claim 47 wherein the mitigating is designed such as to reduce the possibility of alerting the attacker.

50. The system according to claim 47 wherein the system is adapted to determine an occurrence of an attack by applying active validation.

51. An intrusion control system, comprising: an input interface adapted to receive traffic over a session opened between a user and a computerized system; and a processor, adapted to control the session while determining whether the traffic is a part of an attack.

52. The system according to claim 51 wherein the processor is adapted to emulate a response of the computerized system.

53. The system according to claim 51 wherein the processor is adapted to selectively proxy a portion of the traffic to the computerized system.

54. The system according to claim 51 wherein the processor is adapted to provide non-valuable information to the user while determining whether the traffic is a part of an attack.

55. The system according to claim 51 further adapted to reconnect between the user and the computerized system if the traffic is not a part of an attack.

56. The system according to claim 51 further adapted to track a status of traffic such as to facilitate reconnecting the session opened between the user and the computerized system once the determination ended.

57. The system according to claim 51 adapted to determine whether to perform an active validation of the occurrence of an attack.

58. The system according to claim 51 further adapted to mitigate an attack by providing false information representative of a defense capability of a computerized system.

59. A computer readable medium having stored thereon a set of instructions, the set of instructions, when executed by a processor, cause the processor the perform a method that comprises: receiving at least one alert representative of an occurrence of a suspected attack; and determining whether to perform an active validation of the occurrence of an attack.

60. A computer readable medium having stored thereon a set of instructions, the set of instructions, when executed by a processor, cause the processor the perform a method that comprises: determining an occurrence of an attack; and mitigating the attack by providing false information representative of a defense capability of a computerized system.

61. A computer readable medium having stored thereon a set of instructions, the set of instructions, when executed by a processor, cause the processor the perform a method that comprises: receiving traffic over a session opened between a user and a computerized system; and controlling the session while determining whether the traffic is a part of an attack.
